(19) United States
(12) Patent Application Publication
(10) Pub. No.: US 2020/0056823 A1
(43) Pub. Date: Feb. 20, 2020

(54) DEVICE AND METHOD FOR TRANSFORMING STERILE SALINE INTO ICY SLUSH

(71) Applicant: VALORISATION RECHERCHE HSCM, LIMITED PARTNERSHIP, Montreal(Quebec) (CA)

(72) Inventors: Pierre MARSOLAIS, Blainville (Québec) (CA); Richard CÔTÉ, St-Hubert (Québec) (CA); Claude BRISSON, Valcourt (Québec) (CA); René GOSSELIN, Longueuil (Québec) (CA); Yves BERGERON, Racine (Québec) (CA)

(21) Appl. No.: 16/083,405

(22) PCT Filed: Mar. 8, 2017
(86) PCT No.: PCT/CA2017/050310

§ 371 Date: Sep. 7, 2018

Related U.S. Application Data
(60) Provisional application No. 62/305,115, filed on Mar. 8, 2016.

(51) Int. Cl. F25C 1/10; A01N 1/02

(52) U.S. Cl. CPC F25C 1/10; A01N 1/0242; F25C 2301/002; A01N 1/0284; A01N 1/0263

(57) ABSTRACT

A device used for the transformation of large volumes of sterile saline into icy slush in a chilled environment is provided. The sterile saline is provided in commercially available containers and the device has a movable assembly with a plurality of compartments, each sized and configured to receive one or more containers of sterile saline. The movable assembly is operable between an unactuated state and an actuated state so as to agitate the sterile saline in the containers during its transformation into slush. The partitions of the compartments are spaced away from one another to allow movement of the containers in their respective compartments. A method for transforming sterile saline into icy slush for medical, laboratory and surgical applications is also provided.

### CROSS-REFERENCE TO RELATED APPLICATIONS

This application is a National Phase Entry into the U.S. under 35 U.S.C. § 371 of and claims priority to PCT Application No. PCT/CA2017/050310, filed Mar. 8, 2017, which claims priority to U.S. Provisional Patent Application No. 62/305,115, filed Mar. 8, 2016, the entire contents of each being hereby incorporated by reference herein for all purposes.

### TECHNICAL FIELD

The present invention generally relates to the production of icy slush from sterile saline for medical, laboratory and surgical applications, and more particularly relates to devices and methods for which the sterile saline is provided in containers, such as bags and bottles.

### BACKGROUND

Icy sterile surgical slush is used for different types of surgical procedures and for preservation of tissues for laboratory experiments (i.e. pathology, histopathology analysis, etc.). Organs and tissues are placed or preserved in icy sterile saline slush (hypothermic preservation) while outside a body as this reduces their need for oxygen and reduces their metabolism (cell activity), thus reducing potential damage to the tissue or organ. Typically, in the medical field, saline slush is made from a 0.9% sodium chloride solution which is brought at the limit of the freezing point at approximately −0.4° C. and typically saline slush is in the form of icy micro crystals. Sterile saline slush protects the organs and tissues while outside a body, such as during surgeries, tissue laboratory experiments or when being transported for instance, when needed for organ transplant procedures. In the case where multiple organs must be removed, the sterile saline slush is placed inside the body of the donor, so as to protect the organs during the removal procedure.

There exist different types of devices for producing icy sterile slush from saline. One type of well-known device consists of a portable refrigeration unit which includes a cabinet provided with a heat transfer basin on top. A sterile drape is placed over the basin, and sterile saline is poured in the basin while it is refrigerated thereby transforming the saline into icy slush. Ice forming on the walls of the drape is scraped or stirred to produce a loose icy sterile slush. An example of such a device is described in U.S. Pat. No. 4,393,659.

Another well known device consists in a housing provided with a cooling system and carriages to receive specifically designed saline bottles. The saline solution is typically transferred into the bottles which are rotated in the housing under freezing conditions, so as to produce an icy slush. An example of such system is described in U.S. Pat. No. 7,874,167.

One drawback of the existing devices is that the volume of icy slush that they can produce at one time is largely insufficient for some surgical procedures, such as multiple organ removal for example. Some procedures require over 10 liters (L) of icy sterile saline slush within a short period of time, while the output of existing apparatus is limited to no more than 1 to 4 L of icy slush at a time. Another limitation is that prepackaged bags of sterile saline have to be opened so as to transfer the sterile saline to such devices before being frozen to the required texture, a process during which sterility of the saline is compromised. Still another limitation is that such devices have to be in a sterile state before being used. Surgeons and nurses will also resort to using prepackaged bags of sterile saline brought frozen in a freezer that they will repeatedly hit with a sterile hammer or mallet, in order to break the saline ice and manually produce the required quantity of icy slush, although this repeated hitting procedure often causes injury to the personnel. The texture and quality of the icy slush produced this way is not homogeneous, with some ice fragments being sharp, which creates a risk of damaging the organs and tissues placed therein. This procedure can also affect the sterility barrier of the prepackaged bags.

There is thus a need for an improved device, assembly and method for producing icy sterile saline slush that would allow producing larger volumes than the currently existing solutions. It would also be desirable if the device, assembly and method could provide for an icy slush, made from already available containers of sterile saline (such as commercially available prepackaged bags or bottles), with a homogeneous texture. It would also be preferable to eliminate the need for the sterile saline to be transferred to another receptacle during the transformation of sterile saline into slush. It would further be preferable if the device could be fitted into commercial freezers in order to use the capacity of the freezer to bring down the temperature of the saline to optimal temperature for the production of icy slush, such as those already available in hospitals and medical centers for example. Finally, it would be desirable that the device, assembly and method be affordable and easy to manufacture.

### SUMMARY OF THE DISCLOSURE

Broadly described, the disclosure concerns a device, an assembly, and a method for the automated production of icy slush for medical, laboratory and surgical applications, from sterile saline provided in containers, such as bags or bottles.

According to an exemplary embodiment, a device for transforming sterile saline into icy slush in a chilled environment is provided. The sterile saline is preferably provided in commercially available containers. The device comprises a movable assembly, a support structure and an actuating assembly. The movable assembly preferably includes a drum having an outer cylindrical wall, a back side, a front side and a plurality of compartments. The compartments are provided in the drum and are accessible from the front side. The compartments are defined or include partitions, and each compartment is sized and configured to receive one or more containers of sterile saline. The movable assembly is operable between an unactuated state and an actuated state in which the sterile saline in the containers is agitated during its transformation into icy slush. The partitions of the compartments are spaced away from one another to allow tumbling of the containers when the movable assembly is in the actuated state. A support structure supports the movable assembly. The movable assembly is movable relative to the support structure and the actuating assembly is operable to actuate the movable assembly between the unactuated and the actuated states.

According to a possible embodiment, the compartments are sized and configured to allow movement of the containers within the compartments when the movable assembly is in the actuated state such that sidewalls of the containers are not continuously in contact with the partitions.

According to another exemplary embodiment, a method for transforming sterile saline into icy slush is provided. The method includes a step of providing a device in a commercial freezer having a freezing chamber at a temperature between −30° C. and −90° C., the device comprising a plurality of compartments, each being sized and configured for receiving one or more containers (12) of sterile saline. The method includes steps placing containers of sterile saline in at least some of the compartments of the device and of actuating the device to tumble the containers until the sterile saline is transformed into icy slush, wherein during an actuating cycle of the device, sidewalls of the sterile saline containers do not continuously stay in contact with partitions defining the compartments. Preferably, the components of the device have a temperature between −30° C. and −90° C. before starting the process.

The present disclosure describes an improvement over existing devices for it allows to produce icy slush, preferably without any transfer from its original container into another sterile or sterilized container during the transformation of saline into slush, in greater volumes and at a lower cost within a reasonable amount of time and with less manipulation.

Other features and advantages of the disclosed exemplary embodiments will be better understood upon reading the text which follows with reference to the appended drawings.

### BRIEF DESCRIPTION OF THE DRAWINGS

FIG. 1A is a schematic front perspective view of a device, according to an exemplary embodiment of the invention.

FIG. 1B is a back perspective view of the device of FIG. 1A

FIG. 1C is a front view of the device of FIG. 1A.

FIG. 1D is a front view of another possible configuration of a drum, according to a possible embodiment.

FIG. 2A shows a prepackaged bag of commercially available sterile saline, according to a possible embodiment.

FIG. 2B shows a bottle of sterile saline, according to a possible embodiment.

FIG. 2C shows a container of sterile saline inserted in a sheath.

FIG. 2D shows a bottle of sterile saline, according to another possible embodiment.

FIG. 3 is schematic front view of an assembly, according to an exemplary embodiment of the invention.

FIG. 4 is a schematic view of a device, according to another exemplary embodiment of the invention.

FIG. 5 is a schematic view of a device, according to another exemplary embodiment of the invention.

FIG. 6 is a schematic view of a device, according to another exemplary embodiment of the invention.

It should be noted that the appended drawings illustrate only exemplary embodiments of the invention, and are therefore not to be construed as limiting of its scope for the invention may admit to other equally effective embodiments.

### DETAILED DESCRIPTION OF DISCLOSED EXEMPLARY EMBODIMENTS

In the following description, similar features in the drawings have been given similar reference numerals, and, in order to not unduly encumber the figures, some elements may not be indicated on some figures if they were already identified in preceding figures. It should also be understood that the elements of the drawings are not necessarily depicted to scale, since emphasis is placed upon clearly illustrating the elements and structures of the present embodiments.

The present description generally relates to a device and method for producing icy slush for medical, laboratory and surgical applications, from sterile saline provided in containers, such as bags or bottles.

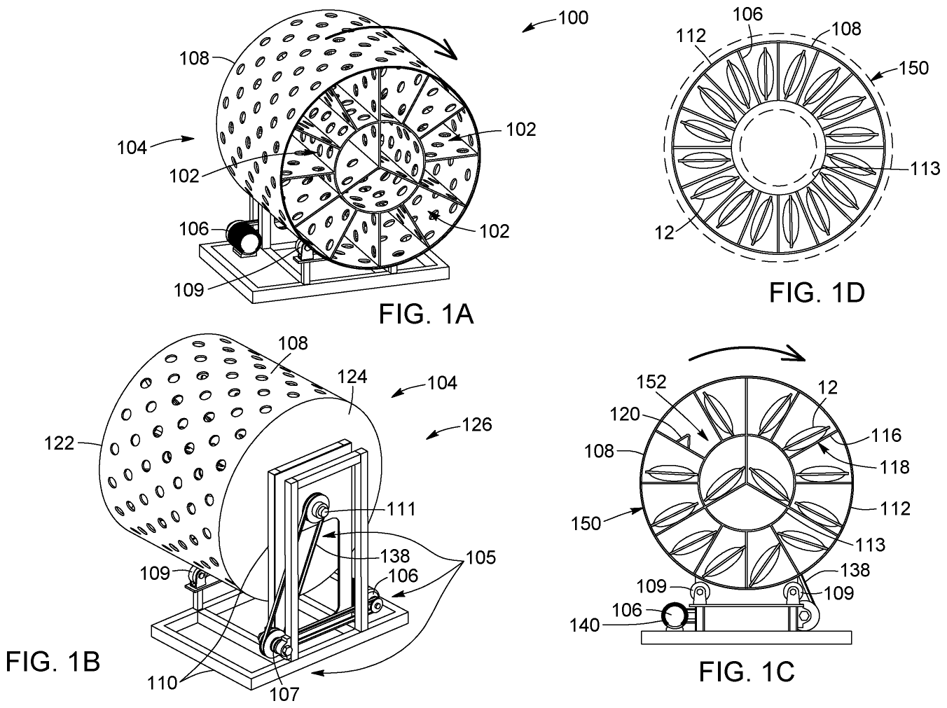

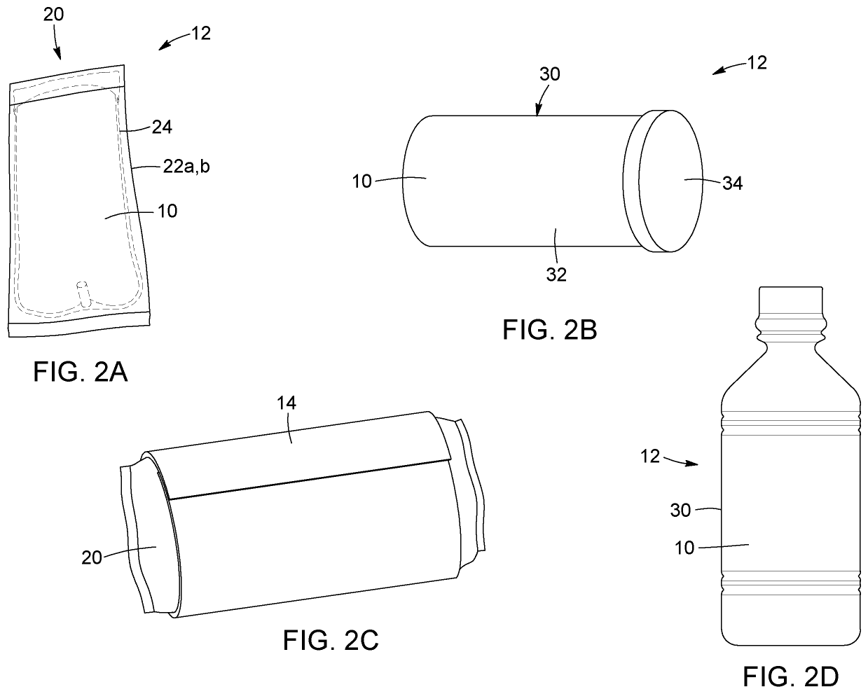

Referring to FIGS. 1A-1C, an exemplary embodiment of a device according to the disclosure is shown. The device 100 comprises at least one, and preferably several compartments 102, for receiving containers of sterile saline. Examples of such containers are shown in FIGS. 2A, 2B and 2D. Such a device (FIG. 1A-1C) can be included in a commercially available freezer. FIG. 1D illustrates another possible embodiment, similar to FIG. 1A-1C, with the difference that there are more compartments 102 and that partitions 116 are closer than in the embodiment of FIGS. 1A-1C.

In FIG. 2A, the container 12 is a flexible container, in the form of a pouch or multi-layer bag assembly 20. The bag assembly 20 typically consists of an inner bag 24 containing the sterile saline 10, surrounded by one or more protective bag layers 22. For example, in the case of the Baxter™ Sterile Container System, the container 12 consists of an inner bag 24 containing the saline 10, also called a “dispensing bag”, with a second protective bag layer 22a, and a third, overwrap layer 22b. The sterile saline solution 10 can comprise water and sodium chloride (NaCl). The containers from Baxter™ contain 1 L of saline, but of course, other types of solutions, bags 20 and volumes of saline can be used with the device of the present disclosure.

In FIGS. 2B and 2D, other possible examples of a container 12 are shown, which, in these cases, are bottles 30. The sides of the bottle 30 are rigid or semi-rigid and made of plastic or metal. The bottle 30 consists in a main body 32 with a removable cap 34. The bottle 30 can be prepackaged with sterile saline 10 by the manufacturer, such as shown in FIG. 2D, which illustrates a 1 L bottle of saline commercially available, or sterilized and prepared on the hospital or medical/research institution premises, such as shown in FIG. 2B. The bottle 30 can be sized and shaped to facilitate the exit of the icy saline slush (i.e. with a neck large enough to prevent clogging of the slush). It is also possible to use bottle containers similar to the one shown in FIG. 2B, for receiving therein bags of saline, with or without the protective layers. Different types of bottle 30 with different volumes of saline can be used with the device of the present disclosure. Of course, other types of containers 12 of various sizes and shapes can be used with the device of the present disclosure.

Referring again to FIG. 1A, and also to FIGS. 1B and 1C, the compartments 102 of the device 100 are sized and configured to receive the different types of containers 12. The compartments 102 are housed within or formed in a movable assembly 104. The movable assembly 104 can also be referred to as a frame assembly, a housing, an enclosure or a structure, which is actuated by an actuator 106 and which can move relative to a support structure 110. The movable assembly 104 is operable between an unactuated state and an actuated state in which the sterile saline in the containers 12 is agitated during its transformation into icy slush. While in the example of FIGS. 1A-1C, the actuating motion is preferably a rotational motion, it is possible to move the movable assembly 104 with other types of motion, such as a vibrational, oscillating or back and forth translational motion. While in the example of FIGS. 1C-1D the containers are placed in a horizontal position, it is possible to put the containers in an upright position. The actuating assembly 105 is operable to actuate the movable assembly 104 between the unactuated and actuated states, such that when in use, the sterile saline in the containers is agitated. The movable assembly 104 is preferably sized and configured to receive at least 8 1 L containers, and preferably at least 10 1 L containers, and still preferably at least 14 1 L containers. As such, the movable assembly 104 preferably comprises at least 8 compartments, and preferably at least 10 compartments, and still preferably at least 14 compartments.

In the present example, the movable assembly 104 comprises a drum or tumbler 108. The movable assembly 104 is supported by the support structure 110, or base, and the drum 108 is rotatably affixed to the support structure 110. The support structure 110 includes vertical legs and a base frame, devised to be in contact or placed in a chilled/freezing environment, such as at the bottom of a commercial freezer. Other configurations are possible. For example, the support structure can include of a closed housing surrounding the drum, to facilitate transport and installation of the device in a commercial freezer. The drum 108 has a central rotational axis oriented substantially horizontally relative to the ground. Rollers 109 can be used to support the weight of the drum and to facilitate its rotation. In the present embodiment, a pair of rollers is located toward the front of the drum 108. The drum 108 has an outer cylindrical wall 112, preferably made of stainless steel or aluminum, and includes partitions or inner sidewalls 116 that form and divide the different compartments 102. The outer cylindrical wall 112 of the drum 108 defines the compartments with the partitions, and moves relative to the support structure 110. The drum 108, partitions and inner walls 116 can be perforated or also be made of a mesh or slightly separated rods to enable cold air to freely circulate and surround the containers while being agitated. The partitions 116 are also preferably made of stainless steel, aluminum or aluminum-alloy, but other materials can be used. For example, the partitions can be made of metals having a thermal conductivity above 10 W/m·K, and preferably above 40 W/m·K and/or metals having a specific heat capacity above 0.4 kJ/(kg·° C.) (which corresponds to 400 J/(kg·K)), and preferably above 0.8 kJ/(kg·° C.) (which corresponds to 800 J/(kgK). Using metals having a high thermal conductivity allows increasing heat transfer from the saline to the partitions, which will results in reducing the temperature of the saline, while materials having a higher specific heat capacity allows to accumulate heat generated by the transformation of saline into slush, which also in turn allows to further reduce the temperature of the saline. Optionally, the material of the partitions is chosen to have enough mass (in kg) to provide an optimized heat transfer from the containers of saline to the partitions. As examples only, 4 kg of aluminum, or 7.8 kg of ferritic stainless steel, or 7.1 kg of austenitic stainless steel would allow accepting about 284 kJ of energy, which approximately corresponds to the energy needed to convert 15 L of saline from approximately 4.5° C. to approximately −0.4° C. Choosing the dimensions of the components of the device (and therefore the mass of metal) so as to increase heat transfers from the containers and the compartments may therefore help reducing the time required to transform the saline into icy slush. Of course, the temperature of the partitions should be at a temperature similar to that of the chilled environment of the freezer, that is between −30° C. and 90° C. Of course, the materials used for the device must be easy to clean, be resistant to rust and humidity as well as to cold temperatures, such as below −80° C.

The temperature of the chilled/freezing environment, in which the device is placed and operates, can vary between 20° C. and 90° C., and preferably between 30° C. and 90° C. Preferably, the device 100 is sized, shaped and configured such that it can be inserted in a commercial freezer with no or limited modifications to the freezer. In other words, the overall dimensions of the device are selected according to the width of the commercial freezer in which the device 100 is to be housed. For example, the overall dimensions of the device are preferably between 25″ (64 cm) and 67″ (170 cm) in height; between 25″ (64 cm) and 35″ (89 cm) in width; and between 25″ and 35″ (89 cm) in depth, in order to fit in a commercially available freezer, while maximizing the number of compartments available to receive saline containers (bags or bottles). In addition, the actuation assembly 105 of the device 100, which is preferably a DC motor, is powered by a electrical outlet 140 which can be distinct and independent from an electrical outlet of the commercial freezer 132. The device 100 can thus operate independently from the freezer, without requiring any electrical modifications to the freezer. Different power sources can be used for the commercial freezer 132 and for the device 100. For example, the freezer may be powered by a 240V-source, while the device operates with a 120V-source. Commercially available freezers typically include an access on their rear side to allow for different probes, and through which electrical cables of the actuating assembly 100 can pass. While in other possible embodiments of the device 100, it can be considered to provide the actuating assembly 105 on the outside of the freezer, the configurations shown in FIGS. 1A-1C and 1D are preferred, since they allow installing the device 100 in the freezer without having to modify said freezer.

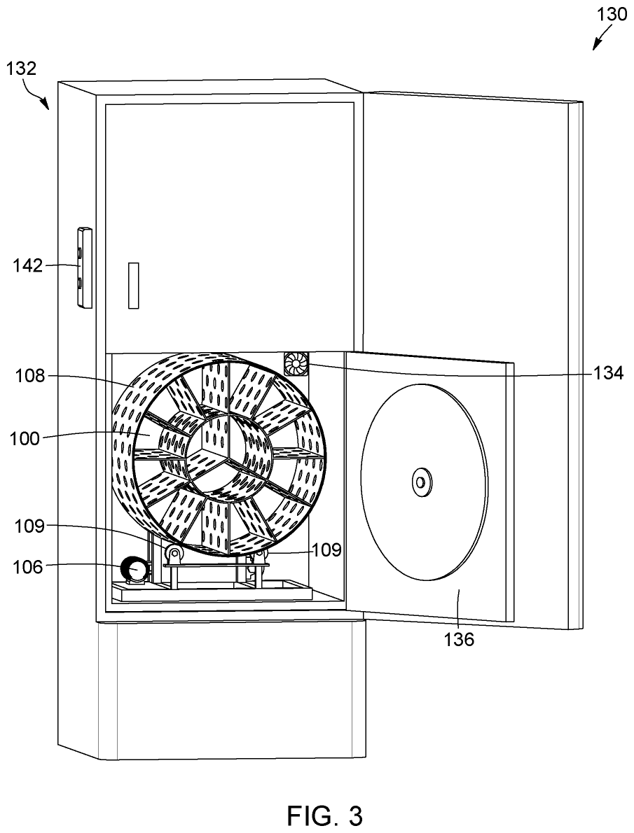

The drum 108 has a front side 122 and a back side 124. When placed in the freezer, the front side 122 faces the door of the freezer, and the back side 124 faces the back wall of the freezer. Still referring to FIGS. 1A-1D and also to FIG. 3, the compartments 102 are sized and configured for receiving one or more of said containers 12 of sterile saline. The partitions 116 of the compartments 102 are spaced away from one another to allow tumbling of the containers 12 when the movable assembly 104 is in the actuated state. By “tumbling”, it is meant that the containers of saline may simply move along with the movable assembly 104, while having sufficient space within the compartments such that sidewalls of the containers are not continuously in contact with the partitions during a rotation cycle of the drum 108, such as shown for example in FIGS. 1C and 1D. The compartments 102 are sized and configured to allow at least small displacements of the containers within their compartment, during a rotation cycle of the drum 108, such that small impacts of the container 12 against the partitions prevents the saline from crystallizing into large ice fragments. In the embodiment of FIG. 1A-1C, the compartments are larger than those of FIG. 1D, and in this case the containers 12 may not only move along the assembly 104, they may also tip over and/or capsize within their compartments, from one of the compartment's partition to the other. In the embodiment of FIGS. 1C-1D, the compartments 102 are sized to receive one container, but other configurations could allow for more than one container per compartment. In such a configurations, the compartment would be large enough to allow for the containers to tumble and move inside the compartment. In possible embodiments, the compartment 102 can be provided with protuberances or tumbling members 120 (such as illustrated in FIG. 1C), to further allow for the tumbling of the containers 12 inside one compartment 102. Such protuberances/tumbling members 120 are of course optional. As shown in FIG. 1A-1C, and also in FIG. 1D, the containers of sterile saline are flexible bags having first and second sidewalls. During a rotation cycle of the drum, for a given bag, one of the bag's sidewalls is in contact with a partition during a portion of the rotation cycle, and the bag's other sidewall is in contact with the opposite partition during a remaining portion of the rotation cycle. In other words, the compartments 102 are sized and configured such that the inner surface 118 of a compartment 102 does not stay in contact with the outer surface of the container 12 it houses during the transformation of saline into icy slush. The volume of the compartments 102 is thus preferably at least larger than the volume of one container 12, so as to allow the container 12 to gently tumble within the compartment 102 as the drum 108 is rotated. This characteristic prevents the formation of plates or lumps of ice in the icy saline slush, which occurs when a portion of the saline stays in close proximity of the cold surfaces of the compartments 102 supporting the containers 12. It is preferable to have a constant agitation of the entire volume of saline within the container so as to form a homogeneous, velvety icy slush. The agitation and/or tumbling of the container allows for the air inside the container to freely move from one side to the other and create a “peristaltic” movement helping the saline crystalizing into slush and prevent lumps of ice. In other words, air within the container is moved in the container, which may create bubbles within the saline, which in turn promotes movement of the saline within the container. Shearing forces must preferably constantly work on the H₂O molecules in the slush so as to prevent large lumps of crystalized ice saline from forming. If the bottom side or lowermost portion of the containers of saline remains in contact with the sidewalls of the compartments, plates of ice tend to form near the interface of the container and the compartment, while the saline near the top side of the container remains as a slush. Tumbling of the containers 12 within the compartments allows for avoiding the formation of undesired ice lumps within the slush. For embodiments where the sidewalls are made of rods or mesh, tumbling of the containers within the compartments may not be required.

Still referring to FIGS. 1A-1D, in both embodiments shown, the partitions 116, defining the compartments 102, extends radially in the drum 108 from the back to the front side of the movable assembly 104. In order to maximize the number of compartments 102 within the movable assembly 104, the drum 108 may be configured with concentric compartment sections 150, 152, such as shown in FIG. 1A-1C. Compartment section 152 comprises three inner compartments, and compartment section 150, which has an annular configuration, comprises twelve sections, providing 15 compartments in total. Of course, other configurations are possible, with different numbers of compartments. In the present example, the sidewalls 116 forming the compartments are made of perforated plates, allowing air to circulate through the movable assembly. However, in other configurations, it is possible that the partitions be continuous or that they be made of a plurality of rods or of a mesh. However, the illustrated configuration is preferred, since the partitions include enough contact surface to promote heat transfer from the saline to the partitions and cold air, while allowing air circulation within the compartments, through the perforations.

As shown in FIG. 3, a door 136 is mounted on the support structure 110, to block access to the movable assembly 104 when in the actuated state. Other configurations are possible: for example, individual doors may be provided on the front side 122 of the drum 108, to close off the compartments when the device is in operation (i.e. when the drum is rotated by the actuator 106). Door(s) may also be located elsewhere on the device and can be formed differently, such as with a mesh for example, and made from different materials. The doors are optional and may not be required, for example if the rotational speed of the drum is slow.

On the back side 124 of the movable assembly 104, a transmission assembly is provided, to transmit the rotational motion of the actuator 106, in this case a drive motor, to the drum 108. The drive motor can be, for example, an AC or DC motor, operating at fixed or variable speed. Preferably, the motor does not generate more than 40 Watts. A lubricant adapted for extreme cold environments is used for the rollers 109 and for the drive motor 106, such as carbon powder for example. Preferably, a DC motor is used, together with a speed reducer 107. For example, the motor can be a 90V DC motor, coupled with a speed reducer having a 40:1 ratio. The transmission assembly 126 can include a hub with gears, chains and/or belts 138. The transmission assembly can also further reduce the speed, such as by a 10:1 ratio. The rotational speed of the drum preferably varies from 2 to 10 rpm, and the drum preferably rotates at 5 rpm. Preferably, the actuator 106 is pre-heated prior to actuating the movable assembly 104. The actuator 106 can be located inside or outside of the chilled/freezing environment (typically inside or outside a freezer). As explained previously, commercial freezers often include a hole on their back wall allowing for power cords and the like to pass through it, such that no or little modification would be needed to the freezer.

Referring now to FIG. 3, an assembly 130 according to an exemplary embodiment of the invention is shown. The assembly 130 includes a freezer 132, with the device 100 inserted therein. As mentioned previously, the freezer 132 is preferably a commercial, off the shelf freezer, with a cooling system allowing the inside of the freezer to be cooled to temperatures between 20 and 90° C. Typically, commercial ultra-low freezers can freeze up to −86° C., but the temperature inside the freezer or freezing chamber during the operation of the device would be about −50 to −70° C., depending on whether the actuator is placed in the freezing chamber or not, and depending on the number of containers in the device. “Flash” or “blast” freezers can also be used. The temperature of the freezing chamber can vary between −30 and −60° C. for this type of freezer. Such freezers are equipped with ventilation systems that continuously pump cold air using fans causing air to circulate in a smooth, laminar fashion.

Still referring to FIG. 3, alternatively, the device 100 may include its own ventilation system 134 to promote air circulation within the movable assembly 104. The fan 134 includes a motor which rotates a hub from which vanes radiate. The fan is preferably placed in the freezer so as to generate a flow of air within the compartments. The front side, back side, cylindrical wall and/or partitions of the drum are thus preferably provided with perforations which allow cooled air to circulate around the containers during operation of the device. The assembly 130 can include a stop/start mechanism 142 linked/connected to the door 136 of the freezer and to the actuator 106, and configured to start the rotation of the drum 108 when the door of the freezer is closed and stop the rotation when the door is opened. Pre-heating of the actuator can be started/controlled using mechanism 142.

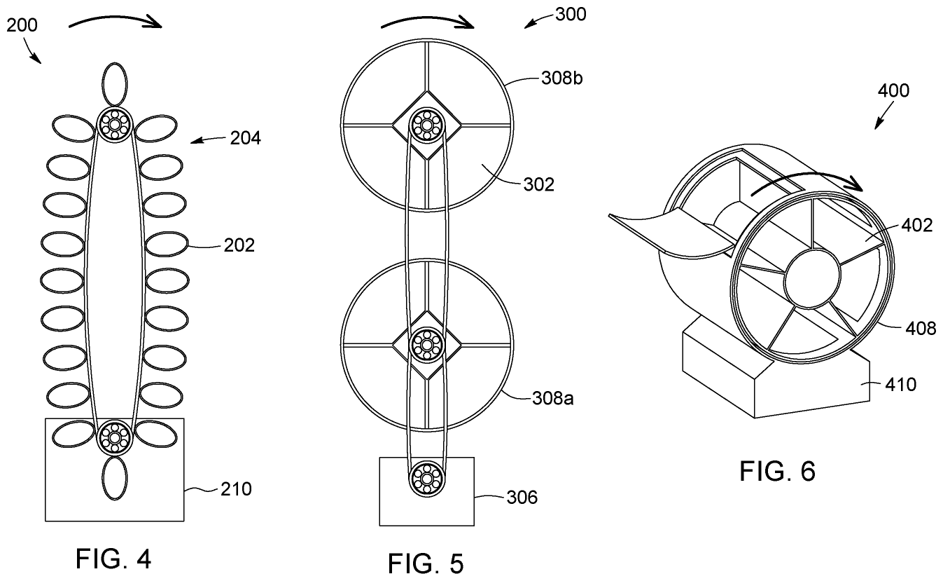

The example of the device and assembly shown in FIGS. 1 and 3 is just one of many possible embodiments of the invention. FIGS. 4, 5 and 6 show other possible embodiments of a device 100. In FIG. 4, the movable assembly 204 of the device 200 includes a conveyer, including for example a rotatable strap, belt or chain, to which a plurality of compartments 202 are affixed. The compartments have an ovoid cross-section and an elongated body especially adapted to receive containers of saline. The movable assembly 204 includes two opposed gears, one of the gears being a drive gear operationally connected to an actuator, while the second gear is a driven gear. The movable assembly has a substantially vertical orientation, which is advantageous when used with vertical, upright freezers. The frame assembly 204 is affixed to the base 210, so as to be rotatable relative thereto.

In FIG. 5, the device 300 includes two drums 308, each with its own rotational axis. The drums 308 are placed one above the other, with their hubs interconnected, for example with a belt. The actuator 306, in this case a drive motor, is connected to the hub of the lower drum 308a. The rotational motion of the drive motor is transmitted to the lower drum 308a and also the upper drum 308b, thanks to the transmission link (belt) connecting the drums 308a and 308b. The motor can be placed inside or outside of the chilled/freezing environment.

In FIG. 6, yet another possible embodiment of a device 400 is provided. In this case, the drum 408 is fixed and rigidly connected to the base 410, and the movable frame assembly is located inside the drum 408. The device 400 includes several compartments, each being sized to receive one or more containers of sterile saline. An access door is located on the top side of the drum 408 and provides access to the compartments 402. The device could include a cooling system for cooling the individual compartments of the device or alternatively be placed in a freezer.

With reference to FIGS. 1 to 5, the method for producing icy sterile saline slush will be explained. A device such as described above is provided in a commercial freezer having a freezing chamber at a temperature between −20° C. and −90° C., and preferably between −30° C. and −90° C. The method is preferably conducted only when the different components of the device, and especially the partitions of the compartments, have reached a temperature between −30° C. and −90° C. The device can have different configurations, but at least comprises a plurality of compartments, each being sized and configured for receiving one or more containers 12 of sterile saline. One or several containers of sterile saline are placed within the compartments. The sterile saline is preferably at a temperature around 4° C., such as between 3° C. and 6° C. prior to being placed in the device. The device is actuated to tumble or move the containers until the sterile saline is transformed into icy slush, wherein during an actuating cycle of the device, sidewalls of the sterile saline containers do not continuously stay in contact with partitions defining the compartments. The containers are placed in compartments in such way that they can move within the compartments. Optionally, the actuator 106 is preheated for a predetermined period of time, such as between 3 and 10 minutes to allow to start at extremely low temperatures. The device is then actuated, preferably so as to continuously rotate the drum of the device during several rotation cycles. Preferably, a sidewall(s) of the containers (or of the sheaths when used) repeatedly hit partitions of the compartments during transformation of the sterile saline into icy slush. Preferably still, the rotational speed of the drum is kept between 2 rpm and 10 rpm, and preferably around 5 rpm, to avoid damaging the containers. Optionally, the actuator can be actuated by closing the door of the freezer. Alternatively, the device can be actuated by an on/off switch, or remotely via a mobile or desktop application. The device is actuated, preferably by rotation, between 0.5 and 4 hours, for at least 5 L of saline, and still preferably, the method allows transforming 10 L, and preferably 14 L of saline, in less than 3.5 hours. Depending on the temperature, size and air circulation inside the compartments of the device, the sterile saline can be transformed into icy slush in less than 5 hours, and preferably in less than 3 hours and preferably in less than 2 hours, and yet preferably in less than 1 hour. Of course, the colder the temperature inside the freezer, the less time is required for the saline to transform into icy slush. Optionally, a photosensitive sensor or other suitable sensors can be provided in the freezer to detect the temperature and/or texture/consistency of the saline. After the saline has been agitated for a predetermined amount of time, the actuator can be stopped or the freezing process can be stopped. The temperature conditions and time period during which the sterile saline is to be agitated, are determined experimentally or with a sensor. The objective is to have the sterile saline transformed into a velvety icy slush.

According to a possible embodiment of the method, the containers 12 can be inserted in sheaths 14, such as shown in FIG. 2C, prior to being placed in the compartments. The sheaths are sized and configured such that the containers 12 (bags or bottles) fit tightly in the sheaths 14. The sheaths are preferably made of a material having a thermal conductivity greater than 40 W/m·K, such as aluminum. Optionally, the sidewalls of the sheaths can include a refrigerant.

As can be appreciated, the device and method described above allows transforming large volumes of sterile saline (typically over 10 L) in a reasonable amount of time, typically less than 3.5 hours. The device and method can be used with commercially available freezers and ultra-low freezers, such as those typically used and readily available in hospitals and medical centers. The device can be installed within a commercial freezer with little or no modifications to the freezer, limiting the installation time and costs. The gentle tumbling or movement of the containers of sterile saline within their respective compartments allows the formation of a smooth, velvety icy slush.

Of course, numerous modifications could be made to the embodiments described above without departing from the scope of the present invention that is set out in the claims below.

1. A device for transforming sterile saline into icy slush in a chilled environment, the sterile saline being provided in containers, the device comprising:
a movable assembly comprising a drum including an outer cylindrical wall, a back side, a front side and a plurality of compartments provided in the drum and accessible from the front side, the compartments being defined by partitions, each compartment being sized and configured for receiving one or more said containers of sterile saline, the movable assembly being operable between an unactuated state and an actuated state in which the sterile saline in the containers is agitated during its transformation into icy slush, the partitions of the compartments being spaced away from one another to allow tumbling of the containers when the movable assembly is in the actuated state;
a support structure supporting the movable assembly, the movable assembly being movable relative to the support structure; and
an actuating assembly operable to actuate the movable assembly between the unactuated and the actuated states.

2. The device according claim 1, wherein the drum has a central rotational axis extending substantially horizontally relative to the ground supporting the support structure.

3-4. (canceled)

5. The device according to claim 1, comprising an annular compartment section including at least some of the compartments for receiving the sterile saline containers, and an inner compartment section disposed in the annular compartment section, said inner compartment section comprising at least some of the compartments for receiving sterile saline containers.

6. (canceled)

7. The device according claim 1, wherein the partitions include perforations, to allow air circulation though the movable assembly.

8. The device according to claim 1, comprising a ventilation system to promote air circulation within the movable assembly.

9. The device according to claim 1, wherein the partitions are made of metal having a thermal conductivity above 10 W/m·K and/or a specific heat capacity above 0.4 KJ/Kg·° C.

10. (canceled)

11. The device according to claim 1, wherein the movable assembly, the support structure and the actuating assembly are sized and configured to fit in a commercial freezer.

12-13. (canceled)

14. The device according to claim 11, wherein the movable assembly is sized and configured to receive at least 8 containers of 1 L.

15-18. (canceled)

19. The device according to claim 1, wherein the actuating assembly comprises is a motor for rotating the movable assembly, the motor generating less than 40 Watts when in the actuated state.

20. (canceled)

21. The device according to claim 19, wherein the movable and actuating assemblies are operable at temperatures between −20 and −90° C.

22. The device according to claim 1, further comprising sheaths for inserting the containers therein, wherein the sheaths are made of a material having a thermal conductivity greater than 40 W/m·K and are sized and configured for receiving commercially available flexible bags of sterile saline and/or bottle containers of sterile saline.

23-26. (canceled)

27. A device for transforming sterile saline into icy slush in a chilled environment, the sterile saline being provided in containers, the device comprising:
a. a movable assembly comprising a drum including an outer cylindrical wall, a back side, a front side and a plurality of compartments provided in the drum and accessible from the front side, the compartments being defined by the cylindrical wall and by partitions, each compartment being sized and configured for receiving one or more of said containers of sterile saline, the movable assembly being operable between an unactuated state and an actuated state in which the sterile saline in the containers is agitated during its transformation into icy slush, the compartments being sized and configured to allow movement of the containers within the compartments when the movable assembly is in the actuated state such that sidewalls of the containers are not continuously in contact with the partitions;
b. a support structure supporting the movable assembly, the movable assembly being movable relative to the support structure; and
c. an actuating assembly operable to actuate the movable assembly between the unactuated and the actuated states.

28. A method for transforming sterile saline into icy slush, the method comprising the steps of:
a) providing a device in a commercial freezer having a freezing chamber at a temperature between −30° C. and −90° C., the device comprising a plurality of compartments, each being sized and configured for receiving one or more containers of sterile saline;
b) placing containers of sterile saline in at least some of the compartments of the device;
c) actuating the device to tumble the containers until the sterile saline is transformed into icy slush, wherein during an actuating cycle of the device, sidewalls of the sterile saline containers do not continuously stay in contact with partitions defining the compartments.

29. The method according to claim 28, wherein step c) comprises placing at least 1 L containers in the device, wherein the containers of sterile saline are commercially available bags or bottles.

30. (canceled)

31. The method according to claim 28, comprising circulating air through the movable assembly of the device during the transformation of sterile saline into icy slush.

32. The method according to claim 28, wherein the device comprises a drum with the partitions extending radially in the drum, and wherein the step of actuating the device comprises rotating the drum relative to a its central rotational axis which extends substantially horizontally relative to the ground supporting the device, the drum being rotated at speeds between 2 rpm and 10 rpm (rotations per minute).

33. (canceled)

34. The method according to claim 28, wherein in step c), sidewall(s) of the containers repeatedly hit partitions of the compartments during transformation of the sterile saline into icy slush.

35. The method according to claim 28, wherein the containers of sterile saline are bags of saline comprising first and second sidewalls, and wherein during step c) one of the sidewalls is in contact with a given one of the partitions during a portion of a rotation cycle, and the other one of the sidewall is in contact with another one of the partitions during a remaining portion of the rotation cycle.

36. The method according to claim 28, wherein step c) is performed between 0.5 hour and 4.5 hours for at least 5 L of sterile saline.

37. (canceled)

38. The method according claim 28, comprising a step of placing the containers of sterile saline in sheaths, the sheaths being made of a material having a thermal conductivity greater than 40 W/m·K.

39-40. (canceled)
